(19) United States
(12) Patent Application Publication
(10) Pub. No.: US 2026/0142409 A1
(43) Pub. Date: May 21, 2026

(54) BREAKAWAY COUPLING

(71) Applicant: ODM GMBH, Wattenheim (DE)

(72) Inventors: Christopher KÜHN, Wattenheim (DE); Herrn David PFLÜGER, Wattenheim (DE); Benjamin BREIDENBACH, Erbach-Erbuch (DE); Tobias BREIDENBACH, Erbach-Erbuch (DE)

(21) Appl. No.: 19/388,075

(22) Filed: Nov. 13, 2025

(30) Foreign Application Priority Data
Nov. 15, 2024 (DE) 102024133554.8

(51) Int. Cl. H01R 13/52; H01R 13/58

(52) U.S. Cl. CPC H01R 13/5202; H01R 13/582

(57) ABSTRACT

A breakaway coupling with a first coupling piece with several contact pins and a second coupling piece to be connected with corresponding contact sockets, wherein the first coupling piece is designed as a coupling shoe and has a circumferential rim which delimits a recess within which the contact pins are arranged in a contact surface, wherein the second coupling piece is designed as a coupling plug and has a shoulder with a circumferential guide surface, wherein the shoulder delimits a plug-in surface in which the contact sockets are arranged.

### FIELD OF THE INVENTION

The invention relates to a breakaway coupling with a first coupling piece, with several contact pins, and with a second coupling piece to be connected with corresponding contact sockets, wherein the first coupling piece is designed as a coupling shoe and has at least a partially circumferential rim that delimits a recess within which the contact pins are arranged in a contact surface, wherein the second coupling piece is designed as a coupling plug and has a shoulder with a circumferential guide surface, wherein the shoulder delimits a plug-in surface in which the contact sockets are arranged.

### BACKGROUND OF THE INVENTION

A breakaway coupling is already known from DE 10 2010 011 271 B4 with two axially interlocking and axially overlapping partial housings, in whose ends connection cables are accommodated.

DE 94 00 329 U1 describes a breakaway coupling for a ten-pole connection of flexible electrical cables.

### SUMMARY OF THE INVENTION

The invention is based on the task of designing and arranging a breakaway coupling in such a way that a wider range of applications is possible.

According to the task is solved by providing a sealing element that can be brought into effective connection with the respective coupling piece when the two coupling pieces are connected. The sealing element ensures that the contacts are protected against water and moisture. The application or forming of the sealing element required to achieve the sealing effect when connecting the coupling pieces requires an additional force V to be applied. An additional force T is also required when separating the coupling pieces. In addition to a force L for releasing the contact pins from the contact sockets, the force T is significantly determined by an initial static friction component between the sealing element or its sealing surface and the relatively moving coupling piece or its inner surface.

According to the invention, this static friction component is taken into account when determining and defining the breaking force so that a tolerance for the breaking force can be maintained.

According to the Invention, the task is also solved by a coupling piece of a
a) with a connection cable for an electronic component A and/or
b) with a connection cable and an electronic component A connected thereto and/or
c) mounted on a housing of a connected electronic component B.

Furthermore, it may be advantageous if
a) the sealing element is arranged on the board and can be pressed sealingly against the guide surface when the two coupling pieces are connected; or
b) the sealing element is arranged on the guide surface and can be pressed against an inner surface of the rim in a sealing manner when the two coupling pieces are connected. The guide surface and the inner surface are the central surfaces that are moved relative to each other. The arrangement of the sealing element in this area minimizes the inner volume of the coupling to be sealed.

It may also be advantageous if the sealing element has a bearing surface and a sealing surface, wherein
a) the sealing element has a triangular cross-sectional shape, wherein the bearing surface and the sealing surface enclose an acute angle_α1, or
b) the sealing element has a rectangular cross-sectional shape, wherein an obtuse angle α2 is enclosed between
i) the guide surface and the plugging surface, or
ii) the inner surface of the rim and the contact surface.

This ensures that when the coupling is released, the sealing element or its sealing surface is immediately lifted off the mating surface, so that the influence on the force T required to separate the coupling only comes into play initially.

It may also be advantageous if the sealing element is designed as an O-ring and is placed within a groove in the inner surface of the rim or within a groove in the guide surface. An O-ring is a very simple and inexpensive means. However, it can be subject to compression deformation, which can lead to leaks. In addition, it has poor tensile and shear strength. Therefore, they are not suitable, or only suitable to a limited extent, for this type of application, which involves high mechanical loads.

It can be advantageous to use a breakaway coupling with a center axis m0 that runs parallel to the guide surface or the rim, or at right angles to the mating surface or contact surface, wherein opposite sections of the guide surface have the same distance a0 from the center axis m0, wherein some of the contact pins are designed as retaining pins and some of the contact sockets are designed as retaining sockets, wherein at least four retaining pins and four retaining sockets are provided, which are placed along the center axis m0. This achieves an in-crease in the holding force, which is accompanied by a corresponding increase in the contact force of the sealing element. This in turn leads to an improved sealing effect. In particular, temperature differences between the environment and the interior to be sealed off can lead to air exchange and thus to moisture ingress if the sealing effect is insufficient,

Of particular importance for the present invention may be when an axis s1 is provided which is arranged parallel to the central axis m0 and has a distance a1 from the section of the guide surface, with a1<a0, wherein at least five contact pins or contact sockets are provided which are placed along the axis s1. The axis s1 runs through the center of the respective contact pin or contact bushing. This means that the breakaway torque is based on a defined force that remains almost the same multiple times, up to 2,000 times.

In connection with the design and arrangement according to the invention, it may be advantageous if an axis s2 is provided, which is arranged parallel to the center axis m0, which has a distance a2 to the section of the guide surface, with a2>a0, wherein at least six contact pins or contact sockets are provided, which are placed along the axis s2. The axis s2 runs through the center of the respective contact pin or contact bushing. A different number of contacts along the two axes s1, s2 is accompanied by an asymmetrical distribution of holding force when the break clutch is opened by tilting around the respective tilt axis.

It can also be advantageous if at least two contact pins or contact sockets, which are placed along the same axis m0, s1, s2, are offset by a measure v relative to this axis m0, s1, s2. This results in an optimal wall thickness between the contact pins on the one hand and the contact sockets on the other.

In addition, it may be advantageous if the sealing element has a sealing surface, wherein the sealing surface is profiled. The profiling ensures a higher contact pressure of the sealing element in the area of a local profile elevation.

Furthermore, it may be advantageous if the sealing surface has circumferential grooves and/or circumferential lamellae with respect to a longitudinal axis. The lamellae have a similar advantageous sealing principle to a shaft seal,

### BRIEF DESCRIPTION OF THE DRAWINGS

Further advantages and details of the invention are explained in the patent claims and in the description and are illustrated in the figures.

FIGS. 1a and 1b show a perspective view of a breakaway coupling in the closed and open states;

FIG. 2 shows a perspective view of both coupling pieces from the front;

FIGS. 3a and 3b show a schematic diagram of the respective coupling piece as viewed from the front;

FIGS. 4a-4c show a perspective sectional view of both coupling pieces in the half-closed and closed states, respectively;

FIGS. 5a, 5b and 5c show a sectional view of the sealing element; and

FIG. 6 shows a schematic diagram of two electronic components with a cable connection with a breakaway coupling.

### DETAILED DESCRIPTION OF THE INVENTION

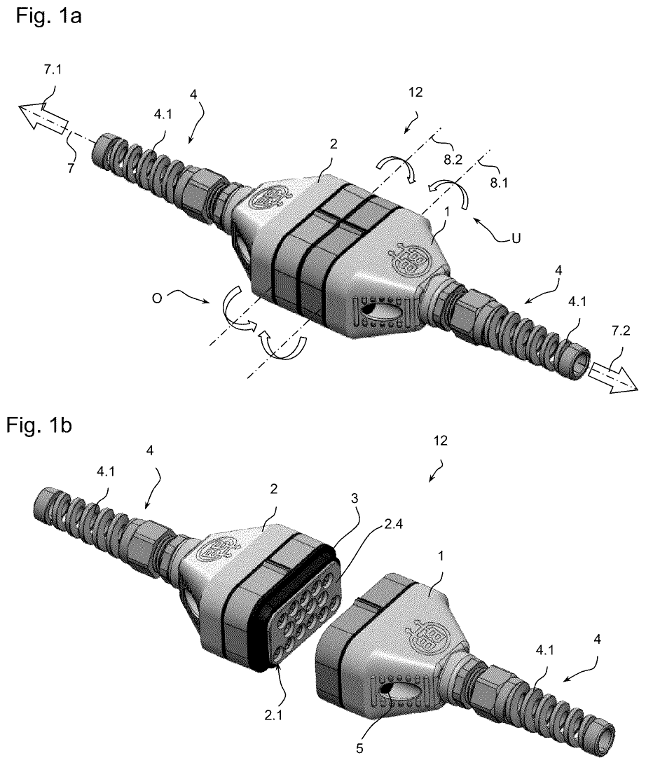

The breakaway coupling shown in FIG. 1a has a first coupling piece 1 and a second coupling piece 2, which are connected to each other. Each coupling piece also has a connection cable 4, which is not shown in detail, and an anti-kink protection 4.1 that is firmly connected to the respective coupling piece. There are several variants for opening the coupling. One variant would be to pull both coupling pieces 1, 2 apart along the longitudinal axis 7, i.e. along the two arrows 7.1, 7.2 pointing in opposite directions, so that the two coupling pieces 1, 2 are separated as shown in FIG. 1b.

As an alternative to this method of pulling apart along the longitudinal axis 7, it would also be possible to open the breakaway coupling by means of a bending movement. In this case, both coupling pieces could be pivoted either downwards (arrow pair U) or upwards (arrow pair O), as indicated by the round arrows, in each case about the respective tilt axis 8.1, 8.2 of the respective coupling piece 1, 2,

In the separated position shown in FIG. 1b, the front side of the second coupling piece 2 is designed as a coupling plug, shown with a plug-in surface 2.4 within which the various contact sockets 2.1, not shown here in detail, are placed. The respective coupling piece 1, 2 consists of several housing parts that are coupled together via a connecting screw 5 or a pair of connecting screws 5.

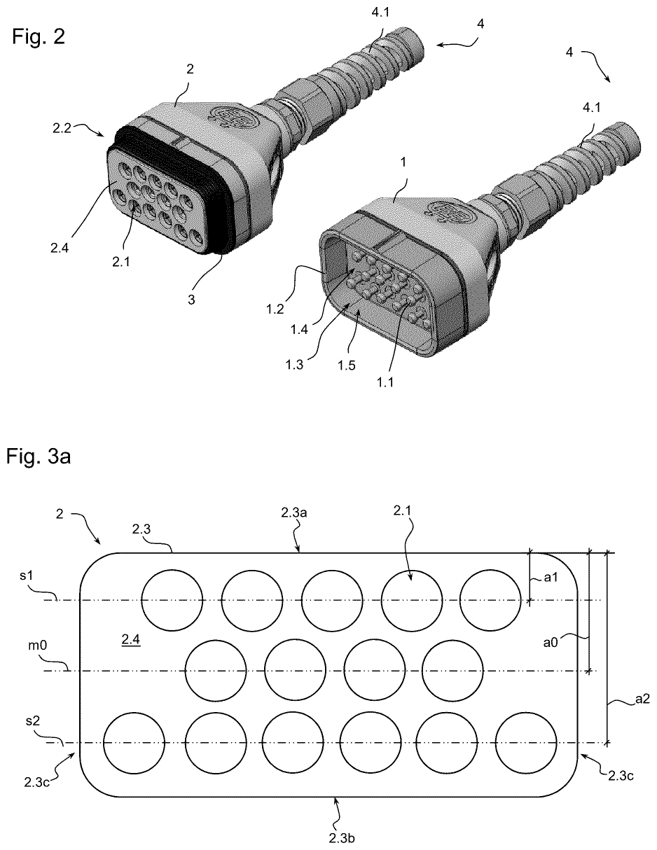

The front view according to FIG. 2 shows, on the one hand, the first coupling piece 1, designed as a coupling shoe, and, on the other hand, the second coupling piece 2, designed as coupling pieces. The coupling shoe 1 is characterized by a rim 1.2, which extends around the circumference as a housing wall segment and which delimits a recess 1.3, which in turn is delimited inwardly by a contact surface 1.4. Several contact pins 1.1 are arranged within the contact surface 1.4, which are connected to the cable (not shown) inside the coupling shoe 1. Each contact pin has a mushroom-shaped basic form and is used for insertion into the respective contact socket 2.1 of the coupling plug 2. The coupling plug 2 has a plug-in surface 2.4, which can be seen here In the front view. Several plug sockets are arranged within the plug-in surface 2.4. The plugging surface 2.4 is bounded on the circumference by a shoulder 2.2, on which a circumferential sealing element 3 is provided. A total of 15 contact sockets 2.1 and, correspondingly, 15 contact pins 1.1 are provided.

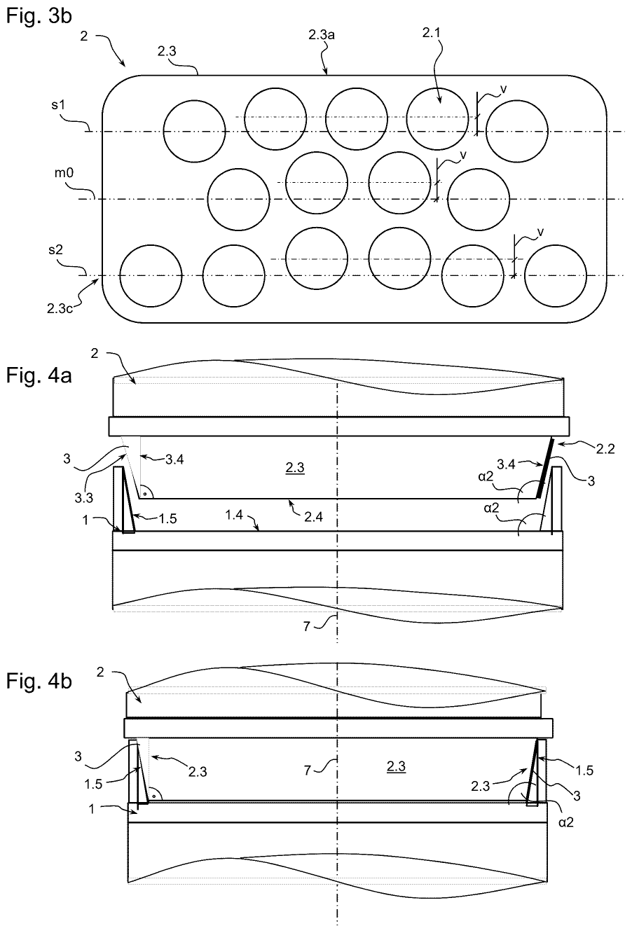

FIG. 3a shows the distribution of the contact sockets and contact pins on the plug-in surface 2.4. The various contact sockets 2.1 are arranged along three axes, a center axis m0 and two further axes s1 and s2. On the center axis m0, which leads to a guide surface 2.3, the plug-in surface 2.4 is limited by the circumference and on which the sealing element is arranged according to FIG. 2. More precisely, the central axis m0 has a distance a0 to a section 2.3a of the guide surface, while the axis s1 has a smaller distance a1 and the axis s2 has a distance a2, which in turn is greater than distance a0. Four contact sockets are arranged next to each other on the center axis m0, five contact sockets are arranged next to each other on the axis s1, and six contact sockets are arranged next to each other on the axis a2. The contact sockets are spaced approximately the same distance apart with respect to their arrangement on the respective axes m0, s1, s2. The distance between the respective outer contact bushing on the respective axis and a right or left section 2.3c of the guide surface 2.3 is significantly greater than the distance between the contact bushings with respect to the axes m0, s1. On the axis s2, the distance to this section 2.3c on the right and left is approximately the same as the relative distance between the contact bushings.

In the embodiment shown in FIG. 3b, some of the contact sockets are offset with respect to the distribution on the respective axes m0, s1, s2. With respect to the axis m0, the two middle sockets are shifted upward by an offset V. With regard to the axis s1, the middle three contact sockets are arranged with an offset V upwards, and with regard to the axis s2, the middle two sockets are also offset upwards by the offset V. The positioning of the corresponding contact pins of the coupling shoe is of course the same so that the contact pins and contact sockets engage coaxially.

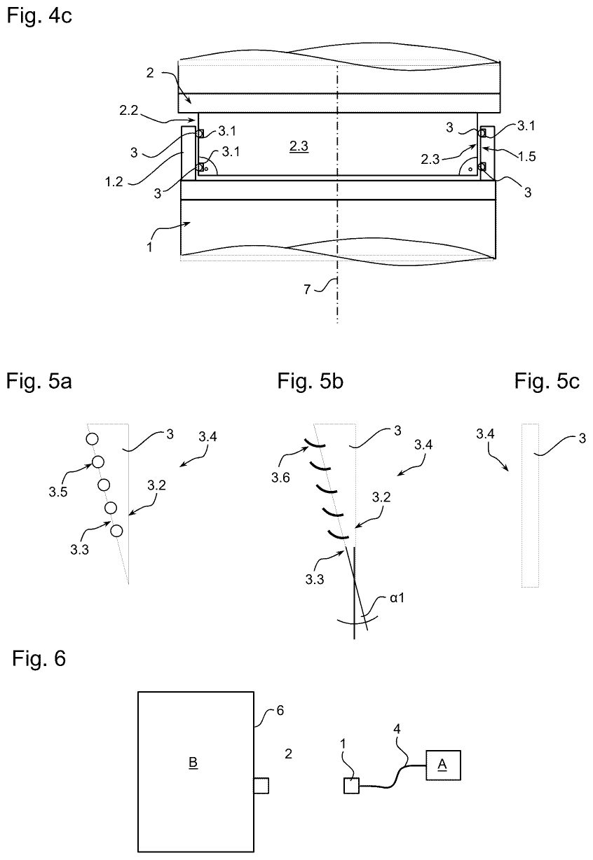

The sectional view shown in FIG. 4a shows the coupling plug 2 and, below it, the coupling shoe 1, The inner surface 1.5 and the contact surface 1.4 form an obtuse angle α2. The sealing element 3 is arranged on the guide surface 2.3 of the coupling plug. According to the embodiment shown in FIG. 4a, left half of the image, the plug-in surface 2.4 and the guide surface 2.3 enclose a right angle. The sealing element, on the other hand, has a triangular cross-sectional shape 3.4, in which a bearing surface 3.2 and a sealing surface 3.3 form an acute angle α1 according to the embodiment shown in FIGS. 5a and 5b. The sum of said right angle and acute angle α1 in turn leads to a sealing surface 3.3 of the sealing element 3 being set at an obtuse angle α2, so that the alignment of the sealing surface 3.3 corresponds to the alignment of an inner surface 1.5 of the coupling shoe 1.

In another embodiment, shown in FIG. 4a, right side, the sealing element or its sealing surface 3.3 is positioned. In contrast to the left half of the image, the circumferential guide surface 2.3 is positioned and forms the said obtuse angle α2 with the plug-in surface 2.4. According to the embodiment shown in FIG. 5c, the sealing element 3 has a rectangular cross-sectional shape 3.4, so that the sealing surface 3.3 has the same orientation as the inner surface 1.5 surrounding the longitudinal axis 7.

This arrangement ensures that, when the two coupling pieces 1, 2 are connected, the sealing element 3 only comes into contact with the inner surface 1.5 at the very last moment of the insertion movement. The same applies when the breakaway coupling is released. At the first moment of a release movement in the axial direction of the longitudinal axis 7, the contact between the sealing element 3 or its sealing surface 3.3 and the inner surface 1.5 is released, so that no friction of the sealing element 3 influences the release force L between the contact pins 1.1 and the contact sockets 2.1.

According to the embodiment shown in FIG. 4b, the coupling plug 2 is fully inserted into the coupling shoe 1. At this moment, the sealing element 3 or its sealing surface 3.3 is sealed against the inner surface 1.5, which is not shown further.

According to the embodiment shown in FIG. 4c, the angle of attack of the guide surface 2.3 and the angle of attack of the sealing surface 3.3 are at right angles. A pair of O-rings can be used as the sealing element, which, according to the embodiment shown on the left half of the image, are arranged in a groove 3.1 of the guide surface 2.3 of the coupling plug, while in the embodiment shown in FIG. 4c, the O-rings are arranged in a groove 3.1 of the inner surface 1.5 of the coupling shoe 1 or the rim 1.2.

In accordance with the sealing architecture according to the embodiment shown in FIGS. 4a-4c, the sealing element 3 can also be provided on the coupling shoe 1 and the sealing surface on the coupling plug 2.

In both FIGS. 5a and 5b, the triangular cross-sectional shape 3.4 of the sealing element 3 can be seen. According to the embodiment shown in FIG. 5a, the sealing surface 3.3 of the sealing element 3 has circumferential beads 3.5 which, in the form of a raised rim above the sealing surface, have a significantly smaller contact area with the inner surface 1.5. This increases the contact pressure for the same plugging force. According to the embodiment shown in FIG. 5b, the sealing element 3 has lamellae 3.6 that protrude above the sealing surface 3.3. The same applies (not shown) to sealing elements 3 with a rectangular cross-sectional shape 3.4 according to FIG. 5 c, in which the sealing surface 3.3 is aligned parallel to the bearing surface 3.2.

According to the embodiment shown in FIG. 6, an electronic component A, such as a speech set, and an electronic component B, such as a communication console, are provided. The electronic component A is connected to a first coupling piece 1 via a connection cable 4. The second electronic component B has a second coupling piece 2 that is mounted on a housing 6 of component B. Thus, component A can be connected to component B by means of the Breaking clutch 12 and disconnected when a corresponding tensile force or tilting moment is applied.

### LIST OF REFERENCE SYMBOLS

1 First coupling piece, coupling shoe
1.1 Contact pin, retaining pin
1.2 Rim
1.3 Recess
1.4 Contact surface
1.5 Inner surface
2 Second coupling piece, coupling plug
2.1 Contact socket, retaining sockets
2.2 Shoulder
2.3 Guide surface
2.3a Section
2.3b Section
2.3c Section
2.4 plug-in surface
3 Sealing element
3.1 Groove
3.2 Bearing surface
3.3 Sealing surface
3.4 Cross-sectional shape
3.5 Bead
3.6 Lamellae
4 Connection cable
4.1 Kink protection
5 Connecting screw
6 Housing of component B
7 Longitudinal axis
7.1 Arrow
7.2 Arrow
8.1 Tilt axis
8.2 Tilting axle
12 Breaking clutch
O Pair of arrows
U Pair of arrows

### Nomenclature

a0 Distance a0
a1 Distance a1
a2 Distance a2
A Component A
B Component B
L Force L
m0 Center axis m0
s1 Axis s1
s2 Axis s2
T Force T
V Dimension v
V Force V
α1 Angle α1, acute
α2 Angle α2, obtuse

What is claimed is:

1. A breakaway coupling, comprising:
a first coupling piece with several contact pins and with a second coupling piece to be connected with corresponding contact sockets,
wherein the first coupling piece is designed as a coupling shoe and has an at least partially circumferential rim which delimits a recess within which the contact pins are arranged in a contact surface,
wherein the second coupling piece is designed as a coupling plug and has a shoulder with a circumferential guide surface, wherein the shoulder delimits a plug-in surface in which the contact sockets are arranged,
wherein the shoulder of the coupling plug can be inserted into the recess of the coupling shoe in the direction of a common longitudinal axis, and
wherein a sealing element is provided which can be brought into operative connection with the respective coupling piece when the two coupling pieces are connected.

2. The breakaway coupling according to claim 1, wherein a) the sealing element is arranged on the rim and, when the two coupling pieces are connected, can be pressed sealingly against the guide surface in the axial direction and/or in the radial direction relative to the longitudinal axis; or b) the sealing element is arranged on the guide surface and, when the two coupling pieces are connected, can be pressed sealingly against an inner surface of the rim in the axial direction and/or in the radial direction relative to the longitudinal axis.

3. The breakaway coupling according to claim 2, wherein the sealing element has a bearing surface and a sealing surface, wherein a) the sealing element has a triangular cross-sectional shape, wherein the bearing surface and the sealing surface enclose an acute angle α1, or b) the sealing element has a rectangular cross-sectional shape, wherein an obtuse angle α2 is enclosed between i) the guide surface and the plug-in surface, or ii) the inner surface of the rim and the contact surface.

4. The breakaway coupling according to claim 1, wherein the sealing element is designed as an O-ring and is placed within a groove of the inner surface of the rim or within a groove in the guide surface.

5. The breakaway coupling according to claim 1, with a center axis m0 arranged at right angles to the plug-in surface or at right angles to the contact surface, wherein opposite sections of the guide surface have the same distance a0 from the center axis m0, wherein a portion of the contact pins are designed as retaining pins and a portion of the contact sockets are designed as retaining sockets, wherein at least four retaining pins and four retaining sockets are provided, which are placed along the center axis m0.

6. The breakaway coupling according to claim 5, with an axis s1 arranged parallel to the center axis m0, which has the distance a1 to a section of the guide surface, with a1<a0, wherein at least five contact pins or contact sockets are provided, which are placed along the axis s1.

7. The breakaway coupling according to claim 5, with an axis s2 that is arranged parallel to the center axis m0, which has a distance a2 to the section of the guide surface, with a2>a0, wherein at least six contact pins or contact sockets are provided, which are placed along the axis s2.

8. The breakaway coupling according to one of claims 5, wherein at least two contact pins or contact sockets placed along the same axis m0, s1, s2 are arranged offset relative to this axis m0, s1, s2 by a quantity v.

9. The breakaway coupling according to claim 1, wherein the sealing element has a sealing surface, wherein the sealing surface is profiled.

10. The breakaway coupling according to claim 9, the sealing surface has circumferential beads and/or circumferential lamellae.
a) with a connection cable for an electronic component A and/or
b) with a connecting cable and a electronic component A and/or
c) mounted on a housing of a connected electronic component B.

12. The breakaway coupling according to claim 2, with a center axis m0 arranged at right angles to the plug-in surface or at right angles to the contact surface, wherein opposite sections of the guide surface have the same distance a0 from the center axis m0, wherein a portion of the contact pins are designed as retaining pins and a portion of the contact sockets are designed as retaining sockets, wherein at least four retaining pins and four retaining sockets are provided, which are placed along the center axis m0, and with an axis s1 arranged parallel to the center axis m0, which has the distance a1 to a section of the guide surface, with a1<a0, wherein at least five contact pins or contact sockets are provided, which are placed along the axis s1.

13. The breakaway coupling according to claim 2, with a center axis m0 arranged at right angles to the plug-in surface or at right angles to the contact surface, wherein opposite sections of the guide surface have the same distance a0 from the center axis m0, wherein a portion of the contact pins are designed as retaining pins and a portion of the contact sockets are designed as retaining sockets, wherein at least four retaining pins and four retaining sockets are provided, which are placed along the center axis m0, and with an axis s2 that is arranged parallel to the center axis m0, which has a distance a2 to the section of the guide surface, with a2>a0, wherein at least six contact pins or contact sockets are provided, which are placed along the axis s2.

14. The coupling according to claim 2, with a center axis m0 arranged at right angles to the plug-in surface or at right angles to the contact surface, wherein opposite sections of the guide surface have the same distance a0 from the center axis m0, wherein a portion of the contact pins are designed as retaining pins and a portion of the contact sockets are designed as retaining sockets, wherein at least four retaining pins and four retaining sockets are provided, which are placed along the center axis m0, wherein at least two contact pins or contact sockets placed along the same axis m0, s1, s2 are arranged offset relative to this axis m0, s1, s2 by a quantity v, wherein the sealing element has a sealing surface, wherein the sealing surface is profiled, and the sealing surface has circumferential beads and/or circumferential lamellae.
